(19) United States
(12) Patent Application Publication
(10) Pub. No.: US 2006/0018472 A1
(43) Pub. Date: Jan. 26, 2006

(54) Facsimile machine and facsimile communication method

(75) Inventor: Yoshifumi Tanimoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Kikai Kabushiki Kaisha, Kyoto-shi (JP)

(21) Appl. No.: 11/185,726

(22) Filed: Jul. 21, 2005

(30) Foreign Application Priority Data
Jul. 26, 2004 (JP) 2004-217967

(51) Int. Cl. H04N 1/44

(52) U.S. Cl. 380/243

(57) ABSTRACT

A facsimile machine of the present invention includes a plurality of encryption processing units, which respectively encrypt transmission data by different encryption methods, an encryption processing determination unit, which transmits the transmission data to either one of the plurality of the encryption processing units, and a transmission unit, which transmits the encrypted transmission data. A facsimile communication method of the present invention applies either one of a plurality of encryption methods, encrypts data by the applied encryption method and transmits the encrypted data.

### BACKGROUND OF THE INVENTION

1. Field of the Invention

The present invention relates to a facsimile machine and a facsimile communication method, and in particular, a facsimile machine and a facsimile communication method having a transmission data encryption function.

2. Description of Related Art

A facsimile machine having an electronic mail function encrypts data, creates electronic mail having the encrypted data as an attached file and transmits the created electronic mail to a remote device.

In general, when encrypting electronic mail, an encryption processing is carried out in accordance with a program handled in an application layer of a communication protocol, for example, the Secure/Multipurpose Internet Mail Extension (S/MIME). By carrying out such an encryption processing, security of the electronic mail at transmission can be improved.

### SUMMARY OF THE INVENTION

Although demand exists for an improvement in security at transmission of electronic mail attached with data, since an advanced encryption processing such as the S/MIME imposes a load on hardware such as a Central Processing Unit (CPU) and a memory of a facsimile machine, a demand also exists for a facsimile machine which reduces such a load.

The present invention has been made in consideration of the above-described circumstances. An advantage of the present invention is to provide a facsimile machine which can prevent a load from being imposed on hardware such as a CPU and a memory in a processing at transmission of transmission data and ensures security in communication.

According to a first aspect of the present invention, a facsimile machine having a transmission data encryption function includes a plurality of encryption processing units, which respectively encrypt transmission data by different encryption methods, an encryption processing determination unit, which transmits the transmission data to either one of the plurality of the encryption processing units, and a transmitter, which transmits the encrypted transmission data.

According to such a facsimile machine, either one of the plurality of the encryption processing units having different encryption processing methods can be selected manually or automatically according to the transmission data. By changing a load imposed on the hardware such as the CPU and the memory for each of the encryption processing methods, a load can be prevented from being imposed on the hardware in the processing at the transmission of the transmission data and security in communication can be ensured.

According to a second aspect of the present invention, the encryption processing determination unit determines to transmit the transmission data to one of the encryption processing units in accordance with a transmission destination of the transmission data. The encryption processing determination unit may determine to transmit the transmission data to one of the encryption processing units in accordance with a communication form of the transmission data.

According to a third aspect of the present invention, an optimum encryption method can be used according to a transmission destination or a communication form.

### BRIEF DESCRIPTION OF THE SEVERAL VIEWS OF THE DRAWINGS

FIG. 1 shows a facsimile machine according to an embodiment of the present invention.

FIG. 2 is a block diagram showing functions implemented by a control unit, a Read Only Memory (ROM), a Random Access Memory (RAM), and according to necessity, a Modulator-Demodulator (MODEM) and a network interface.

FIG. 3 shows a structure of transmission destination data accumulated in a transmission destination database according to an embodiment of the present invention.

FIG. 4 is a flowchart showing an operation relating to an encryption processing of transmission data according to an embodiment of the present invention.

### DETAILED DESCRIPTION OF THE INVENTION

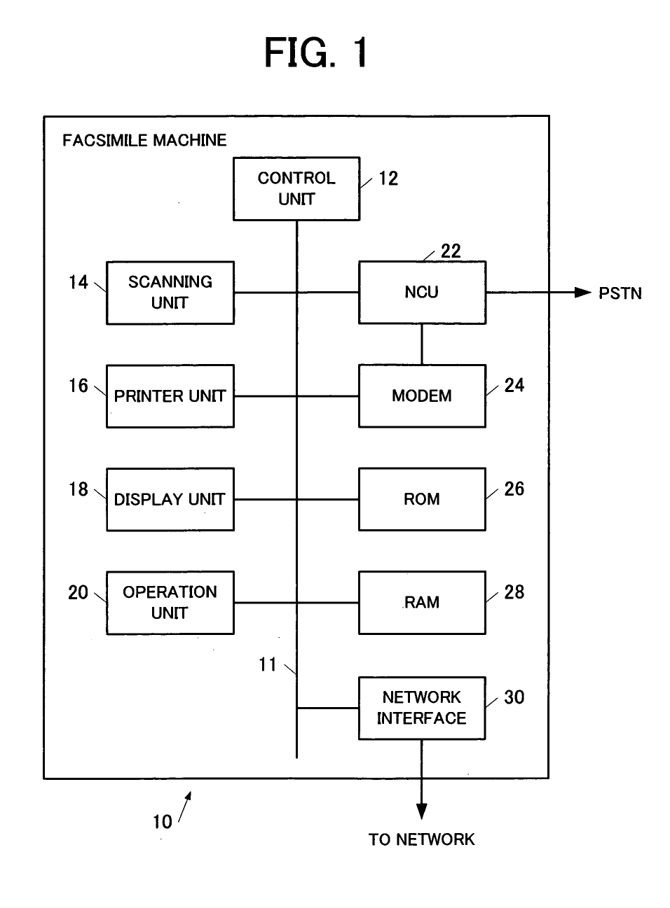

In the following, with reference to the drawings, a detailed description will be made of a facsimile machine according to an embodiment of the present invention. FIG. 1 shows a facsimile machine according to an embodiment of the present invention.

In a facsimile machine 10, a control unit 12, a scanning unit 14, a printer unit 16, a display unit 18, an operation unit 20, a Network Control Unit (NCU) 22, a MODEM 24, a ROM 26, a RAM 28 and a network interface 30 are connected via a bus 11.

The scanning unit 14 includes a line sensor and a Charge Coupled Device (CCD) or the like, which are not shown in the drawings. The scanning unit 14 scans an original document for facsimile transmission, loads the scanned original document as image data and encodes the image data. The scanning unit 14 accumulates the encoded image data and outputs the image data along with data relating to a transmission destination of the image data. The scanning unit 14 may be replaced by a remote computer device for creating image data.

The printer unit 16 includes an electrophotographic printing device, an inkjet printing device or the like. The printer unit 16 prints out a message received from another facsimile machine.

The display unit 18 is, for example, a Liquid Crystal Display (LCD) or a Cathode-Ray Tube (CRT) display. The display unit 18 displays an operational state of the facsimile machine 10, a transmission message and a received message or the like.

The operation unit 20 includes keys necessary for operating the facsimile machine 10. For example, the operation unit 20 includes keys such as a character key, a ten-key numeric pad and a speed dial key for specifying a transmission destination of the image data. The operation unit 20 also includes various function keys such as a key for designating an encryption method and a key for designating a transmission format. Alternatively, the display unit 18 can be formed of a touch screen and a part or all of the function keys of the operation unit 20 can be displayed on the touch screen to provide the display unit 18 as an operation unit.

The NCU 22 carries out a closing operation and a releasing operation of a Public Switched Telephone Network (PSTN). The NCU 22 includes a function for transmitting an address signal according to a telephone number of a destination and a function for detecting a ringing signal. The NCU 22 connects the MODEM 24 and the PSTN according to necessity.

The MODEM 24 functions as a faxmodem which can carry out general facsimile transmission. The MODEM 24 modulates transmission data and demodulates received data. Specifically, the MODEM 24 modulates transmission data into an audio frequency signal and transmits the audio frequency signal via the NCU 22 to the PSTN. The MODEM 24 demodulates the audio frequency signal received from the destination from the PSTN via the NCU 22 into a digital signal.

The ROM 26 previously stores a computer program and information necessary for facsimile transmission and reception. For example, the ROM 26 stores information relating to a function of each structure, an application program for creating electronic mail, a processing program of created electronic mail, a conversion program used in an encryption processing and a decryption processing and a program for decoding encoded image data received from a destination (not shown) of facsimile communication. Further, to respond easily to a correction or an addition of various control programs, a flash memory or the like, which is a rewritable nonvolatile memory, can be used in place of the ROM.

The RAM 28 is formed of a Static RAM (SRAM), a flash memory or the like. The RAM 28 stores temporary data that is generated at an operation of the control unit 12 executed in accordance with a program stored in the ROM 26. The RAM 28 temporarily stores image data encoded by the scanning unit 14.

The network interface 30 is an interface for establishing a connection between the facsimile machine 10 and a network such as a Local Area Network (LAN) and the Internet and transmitting electronic mail to a mail server to be described later.

The control unit 12 controls each operation and as to be described later, transmits encoded image data input from the scanning unit 14, along with the ROM 26 and the RAM 28. When attaching image data to electronic mail and transmitting the electronic mail, the control unit 12 carries out an encryption processing or the like on the electronic mail. Furthermore, the control unit 12 decodes the encoded image data received from a destination (not shown) of the facsimile communication.

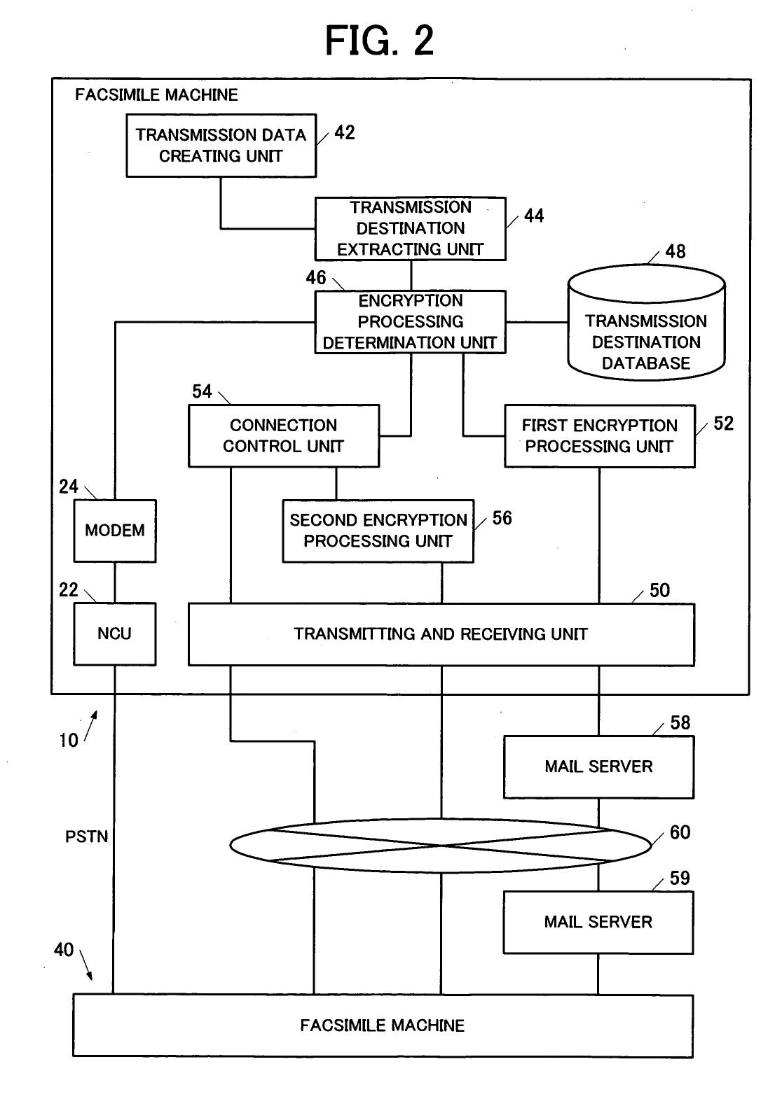

FIG. 2 shows functional blocks implemented by the control unit 12, the ROM 26, the RAM 28 and according to necessity, the MODEM 24 and the network interface 30.

The facsimile machine 10 includes a transmission data creating unit 42, a transmission destination extracting unit 44, an encryption processing determination unit 46, a transmission destination database 48, a transmitting and receiving unit 50, a first encryption processing unit 52, a connection control unit 54 and a second encryption processing unit 56.

The transmission data creating unit 42 creates transmission data from image data transmitted from the scanning unit 14 and a transmission format designated by the operation unit 20.

The transmission destination extracting unit 44 extracts data relating to the transmission destination from the created transmission data. The encryption processing determination unit 46 determines whether or not to encrypt the transmission data by referring to the transmission destination database 48 based on a transmission destination, for example, an individual address, a mail address or an Internet Protocol (IP) address, or based on a communication form, for example, whether or not to transmit via the mail server. The encryption processing determination unit 46 also determines to transmit the transmission data to which one of encryption processing units to be described later when encrypting the transmission data.

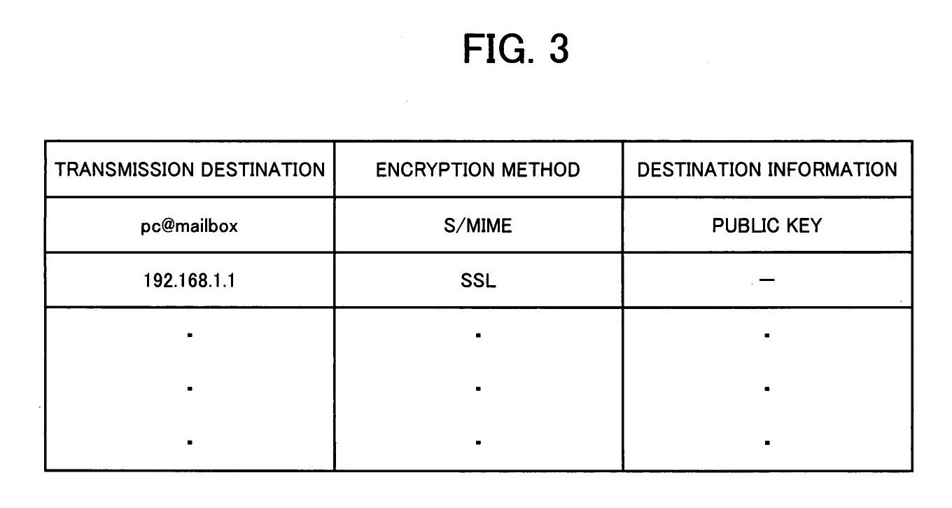

In the transmission destination database 48, a previously registered transmission destination and an encryption method set according to each transmission destination are accumulated by being associated with one another. For example, as shown in FIG. 3, when the transmission destination is a mail address such as “pc@mailbox”, the S/MIME as a first encryption method to be described later is accumulated by being associated with the mail address. When the transmission destination is an IP address such as “192.168.1.1”, the Secure Sockets Layer (SSL) as a second encryption method to be described later is accumulated by being associated with the IP address. Furthermore, when the encryption method starts with the S/MIME, a public key can be accumulated as destination information by being associated with the encryption method.

In the first encryption processing unit 52, when the transmission data transmitted from the encryption processing determination unit 46 is determined to be transmitted via a mail server 58 as to be described later, for example, the first encryption processing unit 52 encrypts the transmission data by the S/MIME method, the Pretty Good Privacy (PGP) method or the like, which is an extension of the encryption method MIME used in electronic mail data. Then, the first encryption processing unit 52 transmits the encrypted transmission data to the transmitting and receiving unit 50.

When the transmission data transmitted from the encryption processing determination unit 46 is determined to be transmitted without through the mail server 58 as to be described later, the connection control unit 54 establishes a connection with another facsimile machine 40 through the Internet 60 from the transmitting and receiving unit 50 to be described later.

In the second encryption processing unit 56, the transmission data transmitted from the encryption processing determination unit 46 through the connection control unit 54 is encrypted by an encryption method, which imposes smaller load on the hardware such as the CPU and the memory than the encryption method used in the first encryption processing unit 52, for example, by the SSL or the Security Architecture for Internet Protocol (IPsec).

A description will be made of a combination of the encryption processing in the first encryption processing unit 52 and the encryption processing in the second encryption processing unit 56. The first encryption processing unit 52 can adopt an encryption method in an application layer, for example, the S/MIME or the PGP method. The second encryption processing unit 56 can adopt an encryption method in a transport layer, for example, the SSL, or an encryption method in a network layer, for example, the IPsec.

The transmitting and receiving unit 50 transmits the transmission data encrypted by the first encryption processing unit 52 to the mail server 58. Alternatively, the transmitting and receiving unit 50 transmits the transmission data encrypted by the second encryption processing unit 56 directly to the facsimile machine 40, which is connected previously via the Internet 60.

The mail servers 58 and 59 transmit and receive data transmitted from a facsimile machine. The mail servers 58 and 59 are connected to one another via the Internet 60. A facsimile machine is connected to each of the mail servers 58 and 59, respectively.

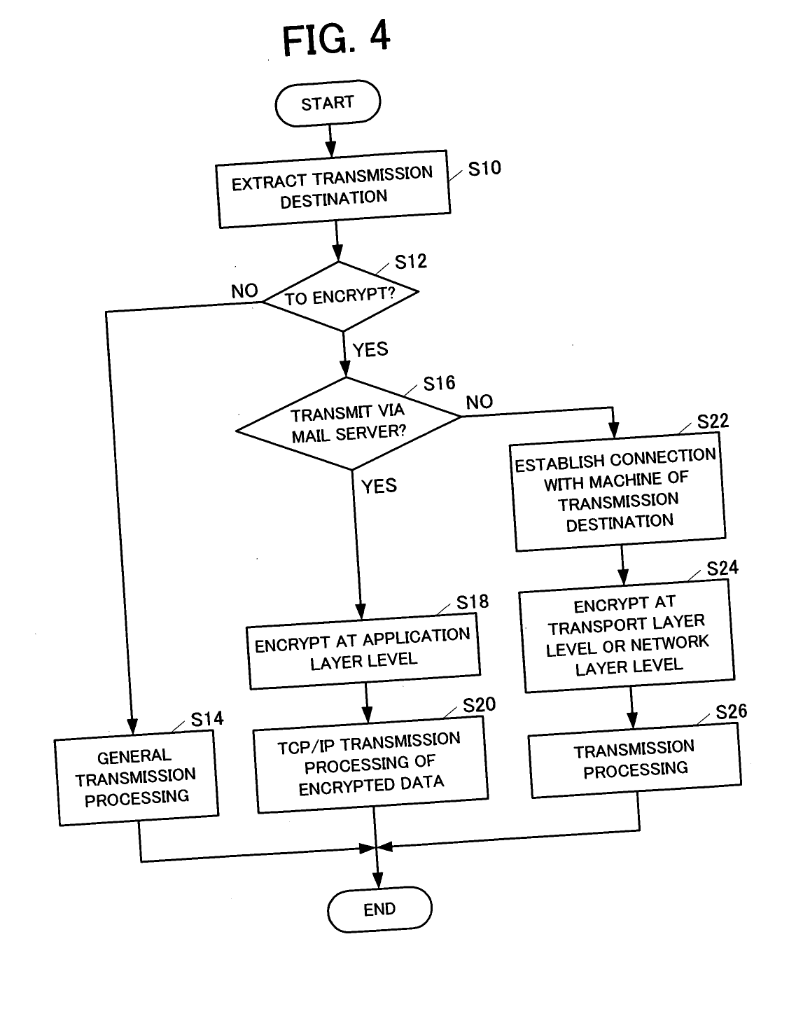

FIG. 4 is a flowchart showing an operation relating to the encryption processing of the transmission data according to the present embodiment. Further, an operation carried out in each step will be described by associating it with the structures shown in FIG. 2. After the transmission data is created by the transmission data creating unit 42, at step S10, as described above, a transmission destination is extracted from the transmission data.

At step S12, by referring to the transmission destination database 48, the encryption processing determination unit 46 determines whether or not the transmission data requires an encryption processing based on the transmission destination extracted at step S10.

When a determination result at step S12 is NO, in other words, when a determination is made that the transmission data does not require an encryption processing, the process proceeds onto step S14. At step S14, a general transmission processing is carried out for the transmission data. That is, the transmission data is transmitted to the other facsimile machine 40 by the Simple Mail Transfer Protocol (SMTP) or the like used in a general transmission protocol and the data transmission operation ends.

When a determination result at step S12 is YES, in other words, when a determination is made that the transmission data requires an encryption processing, the process proceeds onto step S16. At step S16, by referring to the transmission destination database 48, the encryption processing determination unit 46 determines whether or not the transmission data has been planned to be transmitted via the mail server 58. Further, the determination of step S16 may be carried out together with the determination of step S12.

When a determination result at step S16 is YES, in other words, when a determination is made that the transmission data is planned to be transmitted via the mail server 58, the process proceeds onto step S18. At step S18, the first encryption processing unit 52 encrypts the transmission data by the S/MIME or the like. Then, the process proceeds onto step S20. The encrypted transmission data is converted into data, which can be transmitted through the Internet, and the converted data is transmitted to the mail server 58. The data is further transmitted from the mail server 58 through the Internet 60 and eventually to the mail server 59, which is connected to the facsimile machine 40 of the transmission destination. Then, the data transmission operation ends. Further, prior to the encryption processing of step S18, by referring to the table, a confirmation can be carried out as to whether or not a facsimile machine of a recipient can process the encrypted data. In this case, if the facsimile machine of the recipient can process encrypted data, an encryption processing can be carried out. If the facsimile machine of the recipient cannot process encrypted data, the processing can be interrupted and an error processing can be carried out.

When a determination result at step S16 is NO, in other words, when a determination is made that the transmission data is not planned to be transmitted via the mail server 58, the process proceeds onto step S22. At step S22, a connection with the facsimile machine 40 of the transmission destination is established from the connection control unit 54 and the process proceeds onto step S24. At step S24, the second encryption processing unit 56 executes the SSL encryption processing or the IPsec encryption processing on the transmission data. Then, the process proceeds onto step S26. At step S26, the transmission data created at step S24 is transmitted directly to the facsimile machine 40 through the Internet 60 in accordance with a communication protocol in a network layer. Then, the data transmission operation ends.

At step S22, a connection with another facsimile machine is established. Also at step S22, a confirmation can be carried out as to whether or not the other facsimile machine has the same encryption function as the second encryption processing unit 56. If a confirmation is made that the facsimile machine of the recipient can process the encrypted data, an encryption processing can be carried out. If a confirmation is made that the facsimile machine of the recipient cannot process the encrypted data, the processing can be interrupted and an error processing can be carried out. Alternatively, a format of the transmission data can be changed to another method which can be decrypted.

In the present embodiment, a transmission destination extracting unit is provided and according to data of the transmission destination, an encryption method is selected automatically. However, a user (an operator) can manually select the encryption method.

As described above, according to the present embodiment, either one of a plurality of encryption processing units having different encryption processing methods, for example, the first encryption processing unit or the second encryption processing unit, can be selected manually or automatically according to the transmission data. By changing the load imposed on the hardware such as the CPU and the memory for each of the encryption processing methods, a load can be prevented from being imposed on the hardware in the processing at the transmission of the transmission data and security in the communication can be ensured.

According to the above-described facsimile machine and the facsimile communication method, an optimum encryption method can be used according to a transmission destination or a communication form.

1. A facsimile machine with a transmission data encryption function, comprising:
a plurality of encryption processing units which respectively encrypt transmission data by different encryption methods;
an encryption processing determination unit which transmits the transmission data to either one of the plurality of the encryption processing units; and
a transmission unit which transmits the encrypted transmission data.

2. The facsimile machine according to claim 1, wherein the encryption processing determination unit determines to transmit the transmission data to one of the encryption processing units in accordance with a transmission destination of the transmission data.

3. The facsimile machine according to claim 1, wherein the encryption processing determination unit determines to transmit the transmission data to one of the encryption processing units in accordance with a communication form of the transmission data.

4. The facsimile machine according to claim 1, further comprising:
a first encryption processing unit which encrypts the transmission data by using an encryption method of an application layer; and
a second encryption processing unit which encrypts the transmission data by using an encryption method of a transportation layer or a network layer.

5. The facsimile machine according to claim 4, further comprising a database referenced by the encryption processing determination unit to determine to transmit the transmission data to either one of the first encryption processing unit and the second encryption processing unit in accordance with destination information.

6. The facsimile machine according to claim 5, wherein the database stores a public key associated with the encryption method.

7. The facsimile machine according to claim 4, further comprising:
a first transmission unit which transmits the transmission data encrypted by the first encryption processing unit via a mail server to a transmission destination; and
a second transmission unit which transmits the transmission data encrypted by the second encryption processing unit directly to the transmission destination.

8. A facsimile machine with a transmission data encryption function, comprising:
means for encrypting transmission data by either one of a plurality of different encryption methods;
means for determining to apply which one of encryption processing of the means for encrypting on the transmission data; and
means for transmitting the encrypted transmission data.

9. The facsimile machine according to claim 8, further comprising means for determining to apply one of the means for encrypting in accordance with a transmission destination of the transmission data.

10. The facsimile machine according to claim 8, further comprising means for determining to apply one of the means for encrypting in accordance with a communication form of the transmission data.

11. The facsimile machine according to claim 8, further comprising:
means for encrypting the transmission data by using an encryption method of an application layer; and
means for encrypting the transmission data by using an encryption method of a transport layer or a network layer.

12. The facsimile machine according to claim 11, further comprising means for storing by associating with destination information, to apply either one of the encryption method of the application layer and the encryption method of the transport layer or the network layer.

13. The facsimile machine according to claim 12, further comprising means for storing a public key associated with the encryption method.

14. The facsimile machine according to claim 11, further comprising:
means for transmitting the transmission data encrypted by a first encryption method via a mail server to a transmission destination; and
means for transmitting the transmission data encrypted by a second encryption method directly to the transmission destination.

15. A facsimile communication method for transmitting transmission data by encrypting the transmission data, the facsimile communication method comprising the steps of:
determining to apply which one of encryption processing;
encrypting the transmission data by a determined encryption processing; and
transmitting the encrypted transmission data.

16. The facsimile communication method according to claim 15, further comprising the steps of:
designating destination information;
accessing database in accordance with the designated destination information; and
deciding the encryption processing to be applied in accordance with the information stored in the database.

17. The facsimile communication method according to claim 16, further comprising the step of selecting either one of an encryption processing of an application layer and an encryption processing of a transport layer or a network layer as the encryption processing to be applied.

18. The facsimile communication method according to claim 17, further comprising the step of transmitting the transmission data encrypted by the encryption processing of the application layer to a mail server.

19. The facsimile communication method according to claim 17, further comprising the step of transmitting the transmission data encrypted by the encryption processing of the transport layer or a network layer directly to a destination.

20. The facsimile communication method according to claim 19, further comprising the step of encrypting the transmission data by using a public key in the encryption method of the transport layer or the network layer.
